(19) United States
(12) Patent Application Publication
(10) Pub. No.: US 2013/0174439 A1
(43) Pub. Date: Jul. 11, 2013

(54) Diffuser

(71) Applicants: Michael A. Ragosta, Calabasas, CA (US); Bruno Meglio, Beverly Hills, CA (US); Claudio Marino, Woodland Hills, CA (US); David Richmond, Culver City, CA (US); Howard Richmond, Los Angeles, CA (US); Simon Nielsen, El Segundo, CA (US); David Huang, Torrance, CA (US)

(72) Inventors: Michael A. Ragosta, Calabasas, CA (US); Bruno Meglio, Beverly Hills, CA (US); Claudio Marino, Woodland Hills, CA (US); David Richmond, Culver City, CA (US); Howard Richmond, Los Angeles, CA (US); Simon Nielsen, El Segundo, CA (US); David Huang, Torrance, CA (US)

(73) Assignee: M.M. & R. PRODUCTS, INC., Calabasas, CA (US)

(21) Appl. No.: 13/348,502

(22) Filed: Jan. 11, 2012

(51) Int. Cl. A45D 20/04; B05B 1/14

(52) U.S. Cl. 34/283; 34/97; 239/548

(57) ABSTRACT

A diffuser for use with a hair dryer has a body that fits over the outlet of the hair dryer. The diffuser has one or more diffusing features, namely excess mesh, a non-symmetrical rotor, a perforated plate, and diffusion projections extending toward a discharge opening of the diffuser, each projection having a bore with a side orifice for directing air output by the hair dryer radially.

### BACKGROUND

Hair dryers that output a stream of heated air are commonly used for drying hair and for styling. A problem with many conventional hair dryers is that the velocity of the discharged air can adversely affect styled hair.

A variety of diffusers are known for reducing the velocity of air from the hair dryer, such as those described in U.S. Pat. Nos. 4,295,283; 4,525,623; 5,235,759; 5,317,815; 5,715,847; 5,894,849; and 6,966,125. A particularly popular use of diffusers is for drying hair set in small curls. Such curls cannot withstand the force of impact of a powerful stream of air discharged from a hair dryer because direct application of the air to the hair causes the curls to straighten and disturbs their settings.

However, these diffusers suffer from one or more disadvantages of complexity, high cost, and limited effectiveness. For example a problem with most conventional diffusers is that loss of air velocity due to the action of the diffuser can decrease the drying effectiveness of the hair dryer. Hair strands tend to clump together, and the reduced force of air flow resulting from the diffuser can result in inability to break the clumps apart, thereby slowing down the hair drying process. A technique to try to overcome this problem is to manually move the hair dryer to try to break up the clumps, but this can be tiresome.

Accordingly, there is a need for a diffuser for use with hair dryers for reducing the force of impact of air discharged from the hair dryer against the hair that is simple in construction, inexpensive to manufacture, and effective for providing a great reduction in the force. Moreover it is desirable that the reduction be variable.

### SUMMARY

The present invention is directed to diffusers that satisfy this need. The diffusers are for use with a hair dryer outputting air through an outlet. The diffuser has a body having an inlet sized to fit over the outlet of the hair dryer, a discharge opening opposed to the inlet, a gas flow path between the inlet and the discharge opening, and a longitudinal axis. When placed over the hair dryer, the inlet receives air output by the hair dryer. In this invention, there are four features that are useful for diffusing the air. Each of these features can be used separately, or in any combination of two, three, or all four of the features.

The first feature is mesh supported by the body proximate to the discharge opening across at least a portion of this discharge opening for diffusing air blown by the hair dryer. The surface area of the mesh is at least 10% larger than the cross sectional area of the body at the location the mesh is supported by the body (A_{b}). This allows the mesh to flex and undulate as heated air passes through it. Preferably the mesh is across substantially the entire gas flow path. Typically the surface area of the mesh is at least 20% larger than A_{b}, and preferably at least 30% larger than A_{b}. The mesh can be a fabric having no more than about 100 threads per square inch. There is sufficient mesh that by itself it reduces the velocity of the heated air passing through the mesh by at least 10%, preferably by at least 30%, most preferably by at least 50%, and optimally by at least 80%.

The second feature is a non-symmetrical rotor having at least one blade in the flow path mounted to spin by flow of air through the flow path. The blade is effective for pulsing the mesh. When the rotor is used with the mesh, the rotor is closer to the diffuser inlet than is the mesh.

The third feature is a perforated plate, typically bowl-shaped, supported by the body. When the plate is used with the rotor and the mesh, it typically is in the gas flow path between the blade and the mesh.

The fourth feature is a plurality of elongated diffusing projections extending towards the discharge opening. Each projection has a bore with a side orifice for directing air output by the hair dryer radially. The diffusing projections can be supported by the perforated plate when present, and optionally can extend through the mesh.

Preferably the mesh is removable from the diffuser body without use of tools, so that a user can vary the amount of diffusion. For this same purpose, preferably there is a lock for preventing the blade from spinning.

### DRAWINGS

These and other features, aspects, and advantages of the present invention will become better understood with reference to the following description, appended claims, and accompanying drawings where:

FIG. 1 is a schematic view, partially in section, of a diffuser having all four features of the present invention mounted on a hair dryer;

FIG. 2 is an exploded view of a diffuser of FIG. 1;

FIG. 3 is a schematic view, partially in section, of a different version of a diffuser according to the present invention, not having a perforated plate;

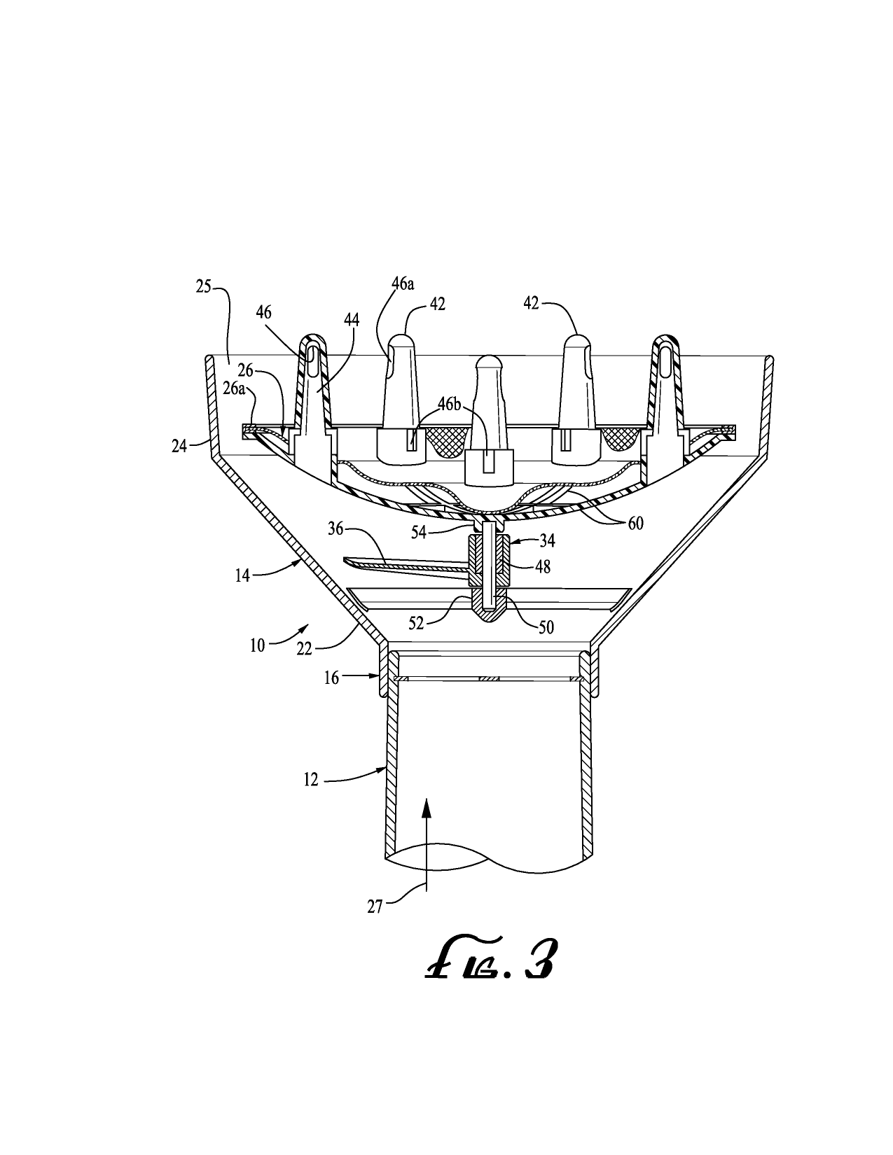

FIG. 4 is an exploded view of the diffuser of FIG. 3; and

FIG. 5 is schematic view of the output portion of a diffuser where the mesh is removable without tools.

### DESCRIPTION

With reference to the figures, a diffuser 10 having features of the present invention is designed for use with a standard hair dryer 12 (only outlet showing), typically having a switch (not shown) for activating the hair dryer by turning it on. The diffuser 10 comprises a body 14 having a longitudinal axis 15. The diffuser 10 has an inlet section 16 having an inlet 18 sized and configured to fit over an outlet 20 of the hair dryer 12. Generally the hair dryer outlet 20 is tubular and circular in cross section, and likewise the diffuser inlet section 16 is tubular and circular in cross section. The diffuser 10 can be placed on the hair dryer before or after the hair dryer is activated.

The diffuser body has a mid conical section 22 and a tubular outlet section 24, with the conical section 22 being between the inlet section 16 and an outlet section 24. The outlet section has an outlet 25, also referred to as a discharge opening. Generally the conical section 22 increases in diameter from the inlet section 16 to the outlet section 24, so that the cross section area for heated air flow 27 (as represented by arrow 27) from the hair dryer 12 increases towards the outlet section 24, thereby reducing the velocity of the heated air discharged by the hair dryer 12.

There will now be described four different features of the diffuser 10 that further assist in diffusing the heated air from the hair dryer 12. Any of these features can be used by itself, or any combination of the features can be used, in combinations of two, three, and four of the features.

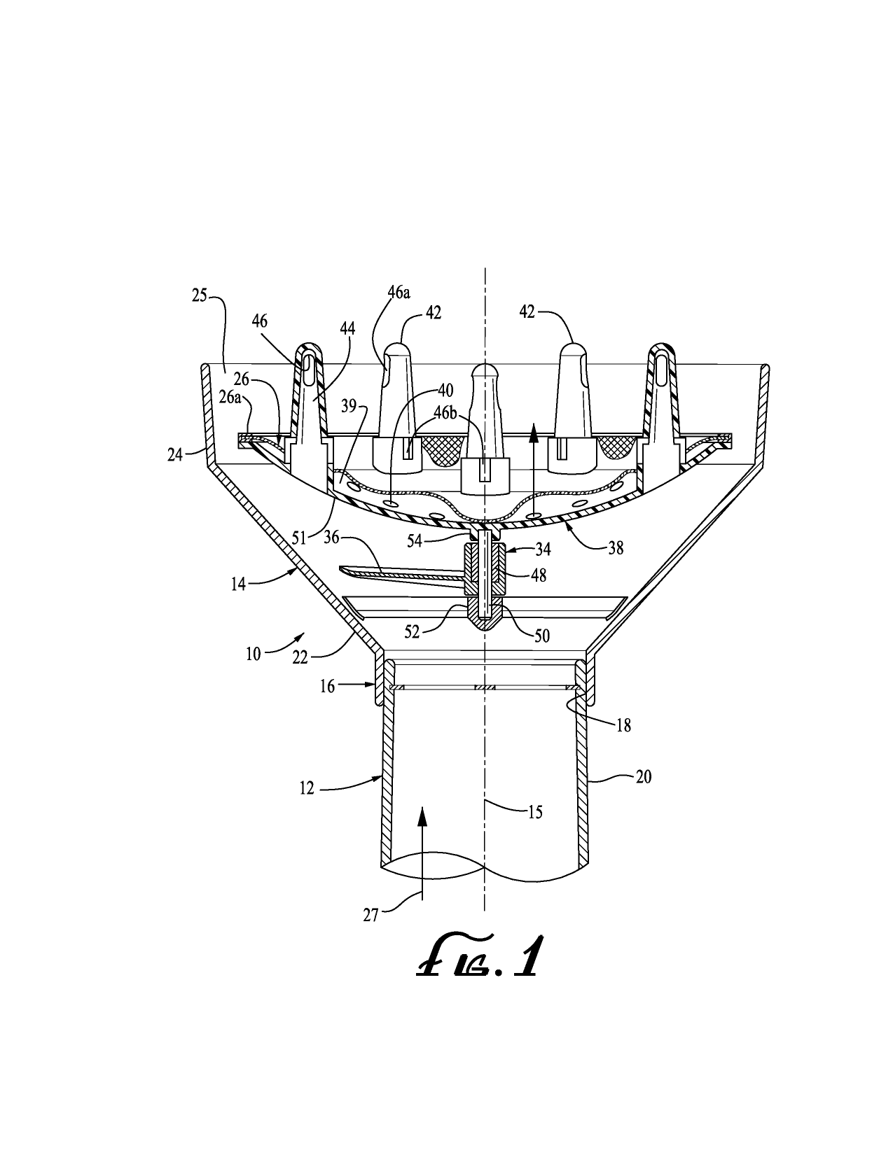

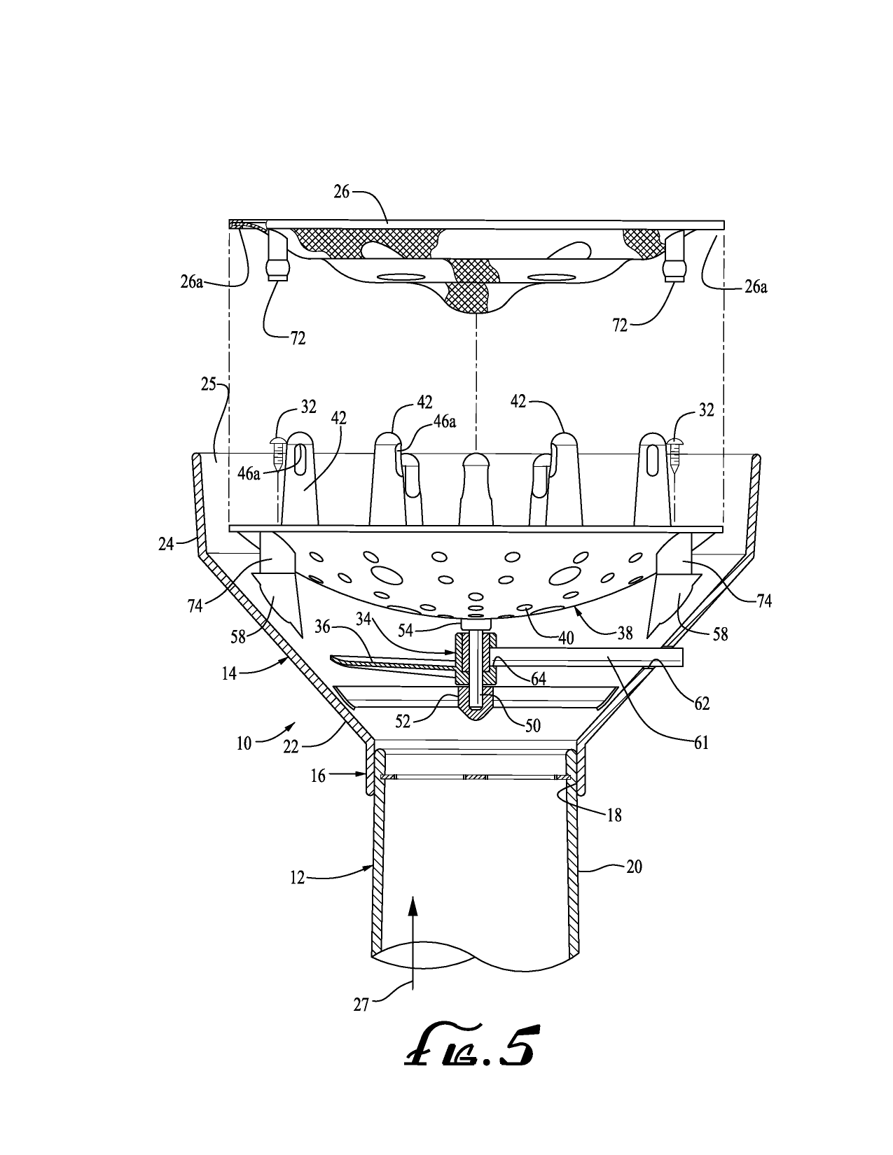

The first feature is mesh 26 that is supported by the body 14, indirectly in FIG. 1, and directly in FIG. 5. By “directly” there is meant that there is no structure between the mesh and the body, and by “indirectly” there is meant that a structure supporting the mesh, and that structure is supported by the body, directly or indirectly. The mesh 26 is oriented to be across at least part of the outlet section 24 of the diffuser 10, in a plane generally perpendicular to the heated air flow 27, which is generally in the direction of the longitudinal axis 15 and held in place with a perimeter, circumferential mesh mounting frame 26a. The frame 26a can be rigid or semi-rigid. It can be held in place on the body 14 by a press fit, snap fit, fasteners, or adhesive.

By the term “mesh” there is meant material of open texture with spaced holes. Typically the spaced holes are evenly spaced, but they need not be. The mesh can be woven, knitted, interlaced or knotted.

Preferably the mesh 26 is across substantially the entire outlet section 24 of the diffuser 10.

As shown in the drawings, there is excess mesh 26 so it is not taut across the body 14. It is desirable that the mesh 26 can flex, flop, and undulate as the heated air 27 passes through it, contributing to the diffusion effect. The mesh 26 deflects a significant amount under the flow of the heated air 27 from the dryer 12, which contributes to the diffusing effect. A user can place hair into the diffuser in contact with the mesh to achieve fast drying. The surface area of the mesh is at least 10% larger than the cross sectional area of the body at the location the mesh is supported by the body (A_{b}). Typically the surface area of the mesh is at least 20% larger than A_{b}, and preferably at least 30% larger than A_{b}. For example, A_{b} can be 50 square centimeters, and the surface area of the mesh can be 65 square centimeters, which is a 30% increase. The mesh can be a fabric made of polyamide or polyester thread having no more than about 100 threads per square inch. There is sufficient mesh that by itself it reduces the velocity of the heated air passing through the mesh by at least 10%, preferably by at least 30%, most preferably by at least 50%, and optimally by at least 80%.

The mesh 26 in its resting configuration is generally bowl shaped, with its concave surface facing toward the discharge opening 25.

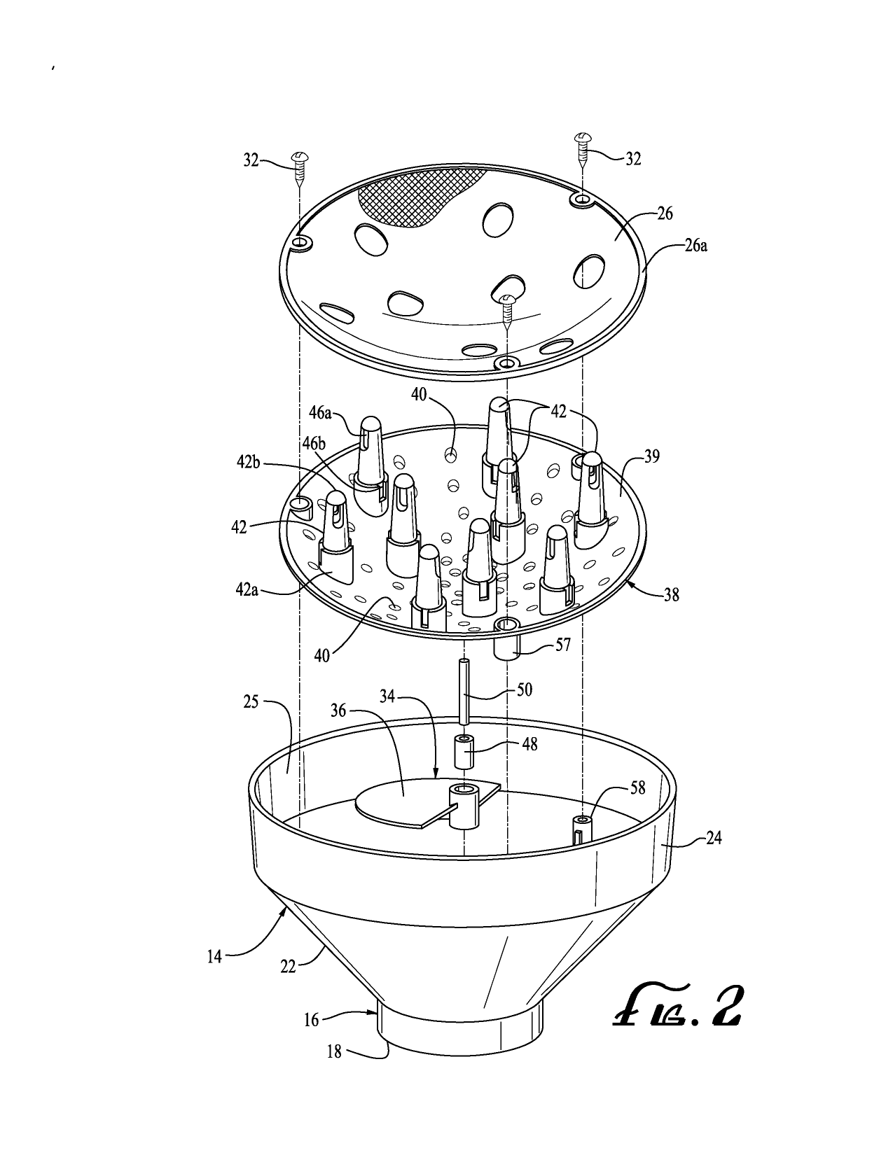

The mesh 26 can optionally be removably mounted at the discharge opening 25 of the diffuser 10, as shown in FIG. 5, such as by a press fit or snap fit so that it can be optionally removed without the use of any tools. Alternatively it can be fastened in place with adhesive or fasteners such as screws 32 as shown in FIG. 2. For example, a plurality of snap fit protections 72 can be received in sockets 34 supported by the body 14. The mesh 26 can be removed before or after placing the diffuser on a hair dryer, and before or after activating the hair dryer.

The mesh 26 can be made of any material such as plastic, metal, or fabric. Preferably it is made of a fabric such as polyamide or polyester thread having no more than about 100 threads per square inch. Preferably it is sufficiently flexible that it reduces the velocity of heated air passing through the mesh by typically at least 10%, preferably by at least 30%, more preferably by at least 50%, and optimally by at least 80%.

The second feature is a non-symmetrical rotor 34. By “non-symmetrical” there is meant that the rotor 34 has only a single partial blade 36, such as shown in the drawings, or has two or more blades that are not equally spaced apart. Because of the non-symmetrical configuration, the heated air 27 is pulsed by the rotor 34, causing pulsing of the mesh 26, thereby contributing to the diffusion.

The third feature is a perforated plate 38, typically bowl-shaped with a concave surface 39 of the bowl facing towards the diffuser discharge opening 25. The plate 38 has sufficient perforations or openings 40 that they account for about 25 to about 75 percentage of the total surface area of the plate 38.

The fourth feature is a plurality of elongated diffusing projections 42 that extend axially parallel to the longitudinal axis 15 of the diffuser body 14. Each projection has a central air passage bore 44 with one or more side orifices 46 for directing heated air, one upper side orifice 46a near the top of the diffusing projection and at least one, and preferably two lower side orifices 46b near the base of the projection, the lower side orifices 46b being evenly spaced around the base, and in the case of two lower side orifices 46b, 180 degrees apart. Typically they are from about five to about fifteen projections, and preferably about ten projections 42.

Typically the projections 42 are about 2.5 to about 4.5 cm long, with a diameter at their base 42a of about 1 cm and at their tip 42b of about 1.5 cm, tapering toward the tips. The base is typically about 1.3 cm in diameter. The projections 42 can have different sizes and shapes from one another i.e., they do not all need to be the same.

With reference to FIG. 2, to assemble the various components of the diffuser 10, the rotor 34 with its blade 36 is secured to a bushing 48 mounted over a pin 50 for rotation thereon, one end of the pin 50 being mounted in a lower socket 52 supported by the diffuser body 14, and the other end in an upper socket 54 on a bottom facing surface 51 of the perforated plate 38. The perforated plate 38 is secured to the diffuser body 14 by fasteners such as the screws 32 extending through tubular guides 57 on the periphery of the plate 38, and then are threaded into corresponding screw receiving openings 58 on the body 14. These are the same screws 32 used for holding the mesh 26 in place.

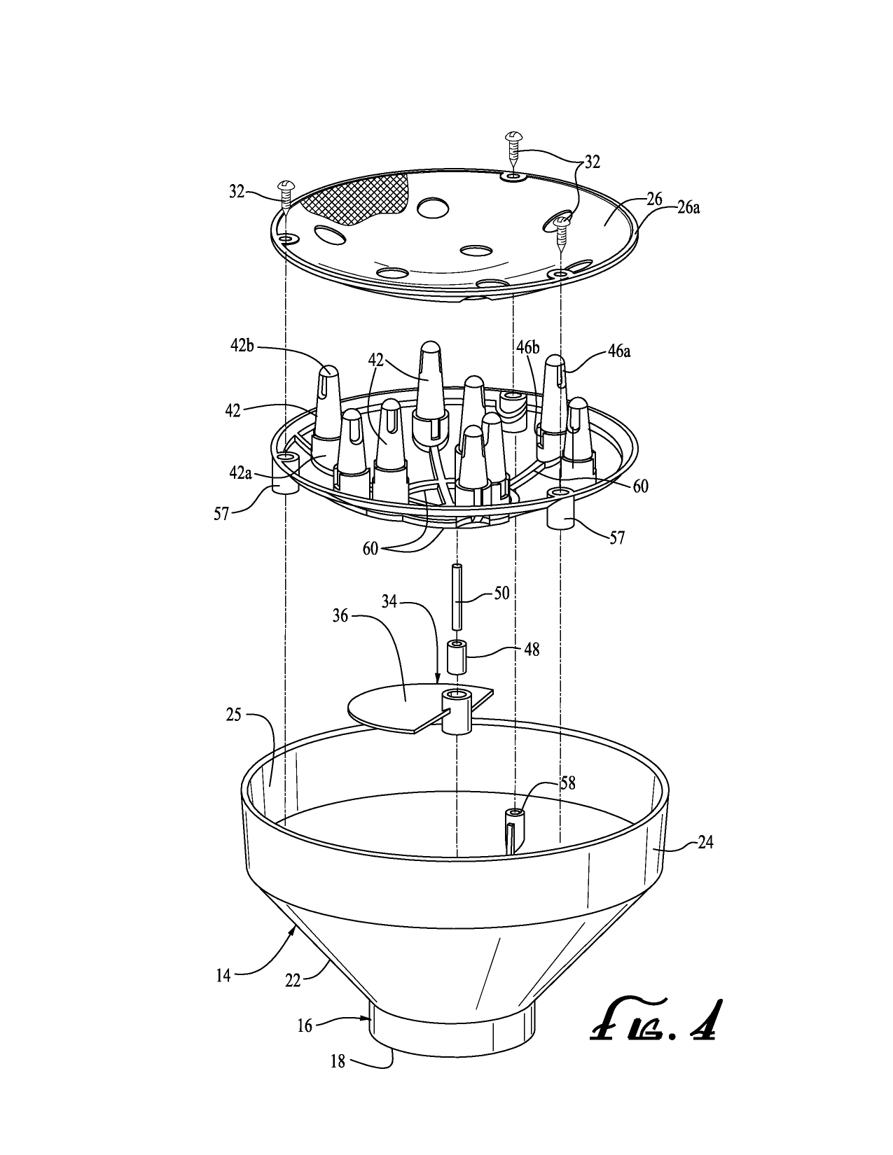

In the version of the invention shown in FIG. 4, the perforated plate 38 is not included. Instead, there is framework 60 used for supporting the rotor 34 and the mesh 26.

The diffuser body can be made of materials conventionally used for diffusers and hair dryers, such as plastic, namely polypropylene.

The preferred fabric is a polyamide having the properties of high heat resistance and flexibility.

The perforated plate is made of material sufficiently heat resistant and rigid to be used in the diffuser, such as a metal or plastic. A preferred material is polycarbonate.

In an optional version of the invention, a lock can be provided for keeping the rotor 34 from spinning to decrease the amount of diffusion. For example, as shown in FIG. 5, a locking pin 61 extends through an opening 62 in the body to engage a receiving socket 64 on the rotor 34 to keep the rotor 34 from spinning. A guide (not shown) can be used to align the locking pin 61 with the socket 64.

To use the diffuser 10 it is placed on the hair dryer 12 at the outlet 20 of the hair dryer 12 with the diffuser inlet 18 proximate to the hair dryer outlet 20. Before or after doing this, but preferably afterwards, the hair dryer is activated to blow heated air through the diffuser 10.

Although the present invention is described in considerable detail with reference to certain preferred versions thereof, other versions are possible. For example, a hair dryer and the diffuser can be provided as a single united unit where the diffuser is removable from the hair dryer only with a tool. Therefore the following claims should not be limited to the preferred versions described herein.

What is claimed is:

1. A diffuser for use with a hair dryer outputting air through an outlet, the diffuser comprising:
a) a body having (i) an inlet sized to fit over the outlet of a hair dryer, the inlet for receiving air output by the hair dryer (ii) a discharge opening opposed to the inlet, and (iii) a gas flow path between the inlet and the discharge opening;
b) a mesh supported by the body proximate to the discharge opening across at least a portion of the discharge opening for diffusing air blown by the hair dryer, the surface area of the mesh being at least 10% larger than the cross sectional area of the body at the location the mesh is supported by the body, A_{b};
c) a non-symmetrical rotor supported by the body and closer to the inlet than is the mesh, the rotor having at least one blade in the flow path mounted to spin by flow of air through the flow path for pulsing the mesh;
d) a perforated plate supported by the body between the blade and the mesh; and
e) a plurality of elongated diffusing projections supported by the perforated plate extending toward the discharge opening, each projection having a bore with a side orifice for directing air output by the hair dryer radially.

2. The diffuser of claim 1 wherein the mesh has at least one projection opening with a projection extending therethrough.

3. A diffuser for use with a hair dryer outputting air through an outlet, the diffuser comprising:
a) a body having (i) an inlet sized to fit over the outlet of a hair dryer, the inlet for receiving air output by the hair dryer (ii) a discharge opening opposed to the inlet, and (iii) a gas flow path between the inlet and the discharge opening;
b) a non-symmetrical rotor having at least one blade in the flow path mounted to spin by flow of air through the flow path; and
c) a plurality of elongated diffusing projections supported by the body extending toward the discharge opening, each projection having a bore with a side orifice for directing air output by the hair dryer radially.

4. The diffuser of claim 3 comprising a perforated plate in the gas flow path and supported by the body between the blade and the discharge opening.

5. The diffuser of claim 3 comprising a mesh supported by the body across at least a portion of the discharge opening for diffusing air blown by the hair dryer, the surface area of the mesh being at least 10% larger than the cross sectional area of the body at the location the mesh is supported by the body.

6. A diffuser for use with a hair dryer outputting air through an outlet, the diffuser comprising:
a) a body having (i) an inlet sized to fit over the outlet of a hair dryer, the inlet for receiving air output by the hair dryer (ii) a discharge opening opposed to the inlet, and (iii) a gas flow path between the inlet and the discharge opening;
b) a non-symmetrical rotor supported by the body, the rotor having at least one blade in the flow path mounted to spin by flow of air through the flow path for pulsing the mesh; and
c) a perforated plate in the flow path and supported by the body.

7. The diffuser of claim 6 comprising mesh supported by the body across at least a portion of the discharge opening for diffusing air blown by the hair dryer, the surface area of the mesh being at least 10% larger than the cross sectional area of the body at the location the mesh is supported by the body.

8. A diffuser for use with a hair dryer outputting air through an outlet, the diffuser comprising:
a) a body having (i) an inlet sized to fit over the outlet of a hair dryer, the inlet for receiving air output by the hair dryer (ii) a discharge opening opposed to the inlet, and (iii) a gas flow path between the inlet and the discharge opening; and
b) mesh supported by the body proximate across at least a portion of the discharge opening for diffusing air blown by the hair dryer, the surface area of the mesh being at least 10% larger than the cross sectional area of the body at the location the mesh is supported by the body, A_{b}.

9. The diffuser of claim 8 comprising a non-symmetrical rotor closer to the inlet than is the mesh, the rotor having at least one blade in the flow path mounted to spin by flow of air through the flow path for pulsing the mesh.

10. The diffuser of claim 9 comprising a plurality of elongated diffusing projections extending toward the discharge opening, each projection having a bore with a side orifice for directing air output by the hair dryer radially.

11. The diffuser of claim 9 comprising a perforated plate supported by the body between the blade and the mesh.

12. The diffuser of claim 8 comprising a plurality of elongated diffusing projections extending toward the discharge opening, each projection having a bore with a side orifice for directing air output by the hair dryer radially.

13. The diffuser of claim 12 comprising a perforated plate supported by the body in the flow path.

14. The diffuser of claim 8 comprising a perforated plate supported by the body in the flow path.

15. The diffuser of claim 1 or 8 wherein the mesh is across substantially the entire flow path.

16. The diffuser of claim 1 or 8 wherein the surface area of the mesh is at least 20% larger than A_{b}.

17. The diffuser of claim 16 wherein the surface area of the mesh is at least 30% larger than A_{b}.

18. The diffuser of claim 1 or 8 wherein the mesh is a fabric having no more than about 100 threads per square inch.

19. The diffuser of claim 1 or 8 wherein there is sufficient mesh that it reduces the velocity of heated air passing through the mesh by at least 10%.

20. The diffuser of claim 8 wherein there is sufficient mesh that it reduces the velocity of heated air passing through the mesh by at least 30%

21. The diffuser of claim 29 wherein there is sufficient mesh that it reduces the velocity of heated air passing through the mesh by at least 50%.

22. The diffuser of claim 21 wherein there is sufficient mesh that it reduces the velocity of heated air passing therethrough by at least 80%.

23. The diffuser of claim 10 or 12 wherein the projections extend through the mesh.

24. The diffuser of claim 6 wherein the plate is bowl shaped with a concave surface facing toward the discharge opening.

25. The diffuser of claim 4 wherein the projections are supported by the plate.

26. The diffuser of claim 8, 9, 12, or 14 wherein the mesh is removable from the body without the use of tools.

27. The diffuser of claim 3 comprising a lock for preventing the blade from spinning.

28. A hair drying apparatus comprising:
a) a hair dryer for outputting heated air through an outlet; and
b) the diffuser of claim 3, 6, or 8 at the outlet.

29. A method for drying hair comprising the steps of:
a) placing the diffuser of claim 8 on a hair dryer having an outlet with the diffuser inlet proximate to the hair dryer outlet;
b) before or after step (a), activating the hair dryer to blow heated air through the diffuser.

30. A method for drying hair comprising the steps of:
a) removing the mesh from the diffuser of claim 26 without the use of tools;
b) before or after step (a), placing the diffuser on a hair dryer; and
c) before or after step (a) and before or after step (b), activating the hair dryer to blow heated air through the diffuser.
